(19) United States
(12) Patent Application Publication
(10) Pub. No.: US 2009/0150134 A1
(43) Pub. Date: Jun. 11, 2009

(54) Simulating Patient-Specific Outcomes

(75) Inventors: Hector De Leon, San Carlos, CA (US); Kapil Gadkar, Mountain View, CA (US); Ananth Kadambi, San Mateo, CA (US); Thomas S. Paterson, Redondo Beach, CA (US); Lyn Powell, San Mateo, CA (US)

Correspondence Address: ENTELOS, INC.;c/o Law Offices of Karen E. Flick, P.O. Box 515, El Granada, CA, 94018-0515, US

(73) Assignee: ENTELOS, INC., Foster City, CA (US)

(21) Appl. No.: 12/269,852

(22) Filed: Nov. 12, 2008

Related U.S. Application Data
(60) Provisional application No. 60/987,412, filed on Nov. 13, 2007.
(60) Provisional application No. 61/029,293, filed on Feb. 15, 2008.

(51) Int. Cl. G06G 7/60

(52) U.S. Cl. 703/11

(57) ABSTRACT

The invention encompasses systems, methods, and apparatus for predicting clinical outcomes and monitoring an individual's response to a therapeutic regimen. The invention further encompasses methods for predicting cardiovascular risk based a genetic marker status and methods for modifying a computer to reflect genetic data and for incorporating genetic markers into a virtual population.

### I. CROSS REFERENCE TO RELATED APPLICATIONS

This application claims the benefit of U.S. provisional patent application no. 60/987,412, filed 12 Nov. 2007 and of U.S. provisional patent application No. 61/029,293, filed 15 Feb. 2008, both incorporated herein by reference in their entirety.

### II. INTRODUCTION

A. Field of the Invention

This invention relates to research involving virtual and actual populations.

B. Background of the Invention

Developments in medicine and information technology are providing patients and physicians with a large and rapidly growing number of information sources relevant to health care. New tests including complex blood-based biomarkers, imaging and genomics are becoming available providing information that is hard to interpret and remains unintegrated with other measures. Every year, new evidence relating to medical diagnosis and treatments are produced by researchers. In addition, access of professionals and patients to this valuable information is becoming increasingly easy. As a result, the amount of information well exceeds the ability of any individual to review, understand and apply this new information. A variety of clinical decision support systems (CDSS) have been developed to aid medical practitioners in seeking and filtering useful, valid information.

However, most clinical decision support systems are limited in their application to very specific tasks. Knowledge-based systems are the most common type of CDSS technology in routine clinical use. Although there are many variations, typically the knowledge within a CDSS is represented in the form of a set of rules. Common CDSS applications include (i) alerts and reminders (ii) diagnostic systems, typically in the form of a decision-tree, (iii) therapy critiquing that does not suggest a therapy, (iv) checking for drug-drug interactions, dosage errors, etc. in the prescription of medications; (v) information retrieval and (vi) image recognition and interpretation.

One computer model that can be used in the clinical setting, called Archimedes, has been developed to simulate the complete healthcare environment, with every person, every doctor and every piece of equipment being represented and interacting as they do in reality. The Archimedes database contains vast amounts of data from numerous epidemiological and clinical trial studies. The data, in combination with the demographics of a virtual community health care system, and information about different treatments, progression of diabetes, medical personnel, facilities, and logistics of medical centers allow Archimedes users to evaluate multiple interventions, including; personal interventions like prevention, diagnosis, screening, treatment and support care, and organizational interventions such as quality improvement, care management, performance measurement, and changes in patient and practitioner behaviors. Eddy and Schlessinger, Diabetes Care 26:3093-3101 (2003) and Eddy and Schlessinger, Diabetes Care 26:3102-3110 (2003). While such a model can be very valuable for studying diseases, it provides no mechanism to evaluate interventions in a real individual.

The American Diabetes Association released an extension of Archimedes, called Diabetes PHD. When a person uses Diabetes PHD and provides information about himself or herself, the system creates a simulated person who has the same characteristics (e.g., sex, age, race/ethnicity), same features (e.g., height, weight, blood pressure), same laboratory test results (e.g., glucose, cholesterol), the same past medical history, family history, symptoms, complications, and the same treatments as the person providing the information. The system then takes this simulated version of the person and creates a thousand “identical looking” people. As a result, the user must wait for these simulations to complete, limiting the interactivity of the system. In addition, while the Archimedes model has been validated against numerous clinical data sets, it is not clear that a prevalence of these individual variations is established.

As a result, it would be desirable to have a system that is capable of assisting clinicians in the diagnosis and/or therapeutic intervention of patients, that can take into account patient-specific data and information including imaging and genomics, and that can scale to a large number of potential users of such a system. Given uncertainty about individual physiology and measurement error, it is important that predictive outcomes provide an appropriate measure of probability of individual patient outcomes.

### III. SUMMARY OF THE INVENTION

One aspect of the invention provides computer-implemented methods of predicting a clinical outcome for a subject comprising: (a) providing a virtual population comprising a plurality of virtual patients; (b) receiving input data about a subject; (c) selecting one or more virtual patients from the virtual population based on a similarity between each of the selected virtual patients and the input data; (d) applying one or more virtual protocols to the one or more selected virtual patients to generate a set of outputs projecting a clinical outcome for the subject, wherein a set of outputs is generated for each selected virtual patient; and (e) reporting the set of outputs to a user. In certain implementations, each virtual patient of the virtual population has an associated prevalence. In such cases, applying one or more virtual protocols to the one or more selected virtual patients can comprise calculating a likelihood of each clinical outcome based upon the prevalence of the one or more virtual patients. The set of output can comprise the likelihood of each clinical outcome or the likelihood of a selected set of clinical outcomes, for example the most likely outcomes or a subset of outcomes representative of the range of clinical outcomes. In certain implementations, the virtual population is a prevalence-weighted virtual population, wherein each virtual patient of the virtual population has an associated prevalence weight. In a preferred implementation, the virtual protocol represents a stimulus selected from the group consisting of a therapeutic regimen, passage of time, exercise, weight gain, diet, a lifestyle choice and a combination of two or more of the same.

Another aspect of the invention provides methods for modifying a computer model of a biological system to reflect genomic information, the method comprising: (a) providing a computer model of a biological system in a computer-readable storage medium; (b) providing a genetic marker having a known association with a clinical phenotype, wherein the genetic marker has a known locus on a chromosome; (c) identifying one or more genes of known biological function that have linkage disequilibrium with the locus of the genetic marker; (d) modifying the computer model to reflect the function of the one or more identified genes; and (e) storing the modified computer model in a computer-readable storage medium. The computer model can modified to directly reflect the function of the one or more identified genes, to directly reflect absence of the function of the one or more identified genes or to indirectly reflect the downstream function of the one or more identified genes. In certain implementations, the method can further comprise (f) executing the modified computer model to generate a simulated outcome; and (g) comparing the simulated outcome with the known association between the genetic marker and clinical phenotype to confirm the validity of the modified computer model. In such a case, comparing the simulated outcome with the known associate between the genetic marker and clinical phenotype optionally can comprise comparing a virtual population with a clinical population.

Yet another aspect of the invention provides methods of incorporating a genetic marker into a virtual population, said method comprising: (a) providing an original virtual population having a set of population constraints; (b) defining the effect of the genetic marker as one or more new axes of variation to be included in generating a new virtual population; (c) generating virtual patients based on (i) the population constraints of the original virtual population and (ii) the one or more new axes of variation; (d) assigning prevalence weights to the virtual population, incorporating population statistics for the genetic marker as a constraint in the prevalence weighting process; and (e) generating an output comprising the virtual population and associated prevalence weights. In certain implementations, the virtual population is provided as data stored on a computer readable medium. In some implementations, each allele for the genetic marker corresponds to a different quantitative position on the new axis of variation. The effect of the genetic marker can be defined as a single new axis of variation or as more than one new axis of variation. In certain implementations, defining the effect of the genetic marker as one or more new axes of variation comprises:(i) identifying the locus of the genetic marker on a chromosome; (ii) identifying one or more genes of known biological function that have linkage disequilibrium with the locus of the genetic marker; and (iii) defining the one or more new axes of variation based upon the known biological function of the one or more genes. the one or more axes of variation can directly reflect the function of the one or more identified genes, directly reflect the absence of the function of the one or more identified genes, or reflect a downstream effect of the function of the one or more identified genes.

Another aspect of the invention provides methods for predicting cardiovascular risk based a genetic marker status, the method comprising: (a) identifying a genetic marker status; (b) providing a computer model of cardiovascular risk configured to account for the genetic marker, wherein the computer model comprises: (i) a representation of cholesterol metabolism, (ii) a representation of atherogenesis, and (iii) a representation of plaque stability, wherein a positive genetic marker status is indicated by an alteration in at least one of cholesterol metabolism, atherogenesis and plaque stability; and (c) simulating and reporting an outcome for a subject. In certain implementations, the genetic marker is a single nucleotide polymorphism (SNP), preferably located at chromosomal locus 9p21, and more preferably is rs10757278(G). In such an implementation, a positive genetic marker status can be indicated by increased smooth muscle cell apoptosis and decreased smooth muscle cell proliferation in a plaque.

It will be appreciated by one of skill in the art that the embodiments summarized above may be used together in any suitable combination to generate additional embodiments not expressly recited above, and that such embodiments are considered to be part of the present invention.

### IV. BRIEF DESCRIPTION OF THE FIGURES

For a better understanding of the nature and objects of some embodiments of the invention, reference should be made to the following detailed description taken in conjunction with the accompanying drawings, in which:

FIG. 1 depicts plaque thickness as a function of degree of inflammation for non-carriers (top curve), heterozygous carriers (middle curve) and homozygous carriers (bottom curve) of rs10757278(G).

FIG. 2 depicts cumulative probability curves for an individual subject, illustrating the probability of occurrence of a myocardial infarction under different scenarios.

FIG. 3 shows a block diagram of a programmable processing system (system) 610 suitable for implementing or performing the apparatus or methods of the invention.

### V. DETAILED DESCRIPTION

### A. Overview

The invention encompasses systems, methods, and apparatus for predicting clinical outcomes and monitoring an individual's response to a therapeutic regimen. The invention further encompasses methods for predicting cardiovascular risk based a genetic marker status and methods for modifying a computer to reflect genetic data and for incorporating genetic markers into a virtual population.

### B. Definitions

The term “population,” as used herein, refers to a group or collection of individuals, either real or virtual. The individuals in the collection of individuals can be from or represent, for example, a group of subjects having a particular disease, treatment history, physiologic or genotypic characteristic(s), and the like. A population is typically a collection of individuals about which one wants to generalize, e.g., the inhabitants of Greenland, cancer patients receiving chemotherapy, severe diabetics, hypertensive rats, etc. The population is typically comprised of mammals of a similar species, e.g. humans.

The term “sample population,” as used herein, refers to a subset of individuals in a population. The sample population can be, for example, the set of individuals participating in a clinical trial. Ideally, a sample population is representative of the population, for example because individuals in the sample population were selected at random from the population, such that observations based upon analysis of the sample population apply to the population as a whole. A sample population can be any small fraction, any moderate fraction, any large fraction, or the entirety of a population.

The term “population characteristics,” as used herein, refers to any qualitative or quantitative features, behaviors, or aspects of the population that are of interest. For example, if the population is cancer patients receiving chemotherapy, the population characteristics may include tumor mass, five-year survival rate, red blood cell (“RBC”) count, and white blood cell (“WBC”) count; if the population is severe diabetics, the population characteristics may include fasting glucose, HbAlc, circulating free fatty acids (“FFA”) concentrations; and if the population is hypertensive rats, the population characteristics may include mean arterial pressure (“MAP”), diastolic blood pressure (“DBP”), systolic blood pressure (“SBP”).

The term “virtual patient,” as used herein, refers to a hypothetical subject, typically a human, including information that is used in and produced by a computer simulation of the hypothetical subject. The computer simulation can be mechanistic or phenomenological in nature. The hypothetical subject can be represented by defining a set of state variables, which can be potentially indicative of or associated with a particular hypothetical physiologic state or condition. The state variables can be determined in whole or in part by models of particular biological systems, processes, or mechanisms. The representation can be, for example, a mathematically explicit vector of parameter values used, for example, in a simulation with a mechanistic model as with the systems described in U.S. Pat. Nos. 6,862,561, and U.S. patent applications bearing publication Nos. 2003-0014232, 2003-0058245, 2003-0078759, 2003-0104475, 2006-0195308, and 2007-00716681 and co-pending U.S. patent application Ser. Nos. 11/681,655, filed 2 Mar. 2007, 11/854,421, filed 12 Sep. 2007, and 11/875,809, filed 19 Oct. 2007.

The term “subject,” as used herein, refers to an actual and existing individual, typically a human and possibly a patient, as distinguished from a virtual patient.

The term “virtual patient population,” as used herein, represents the population characteristics of a population of real subjects, such as a clinical population of interest. The virtual patient population has statistical properties or behaviors (e.g., mean, median, variance, dynamics, etc.) that approximate the statistical properties or behavior of a sample population of real subjects.

The term “prevalence,” as used herein to describe a virtual patient, indicates the occurrence, e.g. the frequency of occurrence, of that virtual patient in a virtual patient population. The prevalence of any particular virtual patient in a virtual patient population can be defined by a weighting factor or weight, wherein each weight adjusts for over- or under-representation of the characteristics of the virtual patient in the population. The prevalence of a virtual patient relates to the likelihood that there is a real subject in the population with characteristics of or similar to the virtual patient.

The term “goodness-of-fit,” as used herein, refers to the similarity of two or more distributions, such as a prediction or simulation compared to an actual observation. Measures of goodness-of-fit include any method or process by which one quantifies and/or qualifies such similarity. Qualitative measures include visual inspection and comparison of plots or other graphical representations of the distributions. Quantitative measures include statistically rigorous methods by which one quantifies the total deviation of one set of values from another, for example, using a Chi-square test, G-test, Analysis of Covariance (ANCOVA), or Kolmogorov-Smimov test. Measures of goodness-of-fit can include both qualitative and quantitative aspects, such as non-parametric measures including ranked or categorized pairwise comparisons.

The term “mechanistic model,” as used herein, refers to a computational model, for example a model having a set of differential equations, that describes the characteristics or behavior of a system, for example, a biological system. Mechanistic models can be causal models, which typically link two or more causally-related variables in a mathematical relationship that reflects the underlying mechanism(s), for example the biological mechanisms, affecting those variables.

The term “biological system,” as used herein, refers to any system of interacting or potentially interacting biological constituents whose behavior can be characterized in whole or part by one or more biological processes or mechanisms. A biological system can include, for example, an individual cell, a collection of cells such as a cell culture, an organ, a tissue, a multi-cellular organism such as an individual human patient, a subset of cells of a multi-cellular organism, or a population of multi-cellular organisms such as a group of human patients or the general human population as a whole. A biological system can also include, for example, a multi-tissue system such as the nervous system, immune system, or cardio-vascular system.

The term “biological constituent,” as used herein, refers to a portion of a biological system. A biological constituent that is part of a biological system can include, for example, an extra-cellular constituent, a cellular constituent, an intra-cellular constituent, or a combination of them. Examples of biological constituents include DNA; RNA; proteins; enzymes; hormones; cells; organs; tissues; portions of cells, tissues, or organs; subcellular organelles such as mitochondria, nuclei, Golgi complexes, lysosomes, endoplasmic reticula, and ribosomes; and chemically reactive molecules such as H⁺, superoxides, ATP, citric acid, protein albumin, and combinations of them.

The term “cellular constituent,” as used herein, refers to a biological cell or a portion thereof. Nonlimiting examples of cellular constituents include molecules such as DNA, RNA, proteins, glycoproteins, lipoproteins, sugars, fatty acids, enzymes; hormones, and chemically reactive molecules (e.g., H+; superoxides, ATP, and citric acid); macromolecules and molecular complexes; cells and portions of cells, such as subcellular organelles (e.g., mitochondria, nuclei, Golgi complexes, lysosomes, endoplasmic reticula, and ribosomes); and combinations thereof.

The term “biological process,” as used herein, refers to an interaction or set of interactions between biological constituents of a biological system. In some instances, a biological process can refer to a set of biological constituents drawn from some aspect of a biological system together with a network of interactions between the biological constituents. Biological processes can include, for example, biochemical or molecular pathways. Biological processes can also include, for example, pathways that occur within or in contact with an environment of a cell, organ, tissue, or multi-cellular organism. Examples of biological processes include biochemical pathways in which molecules are broken down to provide cellular energy, biochemical pathways in which molecules are built up to provide cellular structure or energy stores, biochemical pathways in which proteins or nucleic acids are synthesized or activated, and biochemical pathways in which protein or nucleic acid precursors are synthesized. Biological constituents of such biochemical pathways include, for example, enzymes, synthetic intermediates, substrate precursors, and intermediate species.

Biological processes can also include, for example, signaling and control pathways. Biological constituents of such pathways include, for example, primary or intermediate signaling molecules as well as proteins participating in signaling or control cascades that usually characterize these pathways. For signaling pathways, binding of a signaling molecule to a receptor can directly influence the amount of intermediate signaling molecules and can indirectly influence the degree of phosphorylation (or other modification) of pathway proteins. Binding of signaling molecules can influence activities of cellular proteins by, for example, affecting the transcriptional behavior of a cell. These cellular proteins are often important effectors of cellular events initiated by a signal. Control pathways, such as those controlling the timing and occurrence of cell cycles, share some similarities with signaling pathways. Here, multiple and often ongoing cellular events are temporally coordinated, often with feedback control, to achieve an outcome, such as, for example, cell division with chromosome segregation. This temporal coordination is a consequence of the functioning of control pathways, which are often mediated by mutual influences of proteins on each other's degree of modification or activation (e.g., phosphorylation). Other control pathways can include pathways that can seek to maintain optimal levels of cellular metabolites in the face of a changing environment.

Biological processes can be hierarchical, non-hierarchical, or a combination of hierarchical and non-hierarchical. A hierarchical process is one in which biological constituents can be arranged into a hierarchy of levels, such that biological constituents belonging to a particular level can interact with biological constituents belonging to other levels. A hierarchical process generally originates from biological constituents belonging to the lowest levels. A non-hierarchical process is one in which a biological constituent in the process can interact with another biological constituent that is further upstream or downstream. A biological process often has one or more feedback loops. A feedback loop in a biological process refers to a subset of biological constituents of the biological process, where each biological constituent of the feedback loop can interact with other biological constituents of the feedback loop.

The term “biological mechanism,” as used herein, refers to an underlying biological, e.g. physiological, process that gives rise to a clinically observable characteristic or behavior. Biological mechanisms may incorporate or be based on biological processes such as, e.g., the binding of a drug to a receptor (including, e.g., the binding constant); the catalysis of a particular chemical reaction, e.g., an enzymatic reaction (including, e.g., the rate of such a reaction); the synthesis or degradation of a cellular constituent, such as a molecule or molecular complex (including, e.g., the rate of such synthesis or degradation); the modification of a cellular constituent, such as the phosphorylation or glycosylation of a protein (including, e.g., the rate of such phosphorylation or glycosylation); and the like. A biological mechanism also can involve an interaction of one biological constituent with another, for example, a synthetic transformation of one biological constituent into the other, a direct physical interaction of the biological constituents, an indirect interaction of the biological constituents mediated through intermediate biological events, or some other mechanism. An interaction of one biological constituent with another can include, for example, a regulatory modulation of one biological constituent by another, such as an inhibition or stimulation of a production rate, a level, or an activity of one biological constituent by another, and may constitute a biological system's synthetic, regulatory, homeostatic, or control networks. A biological mechanism can be known or unknown.

The term “biological state,” as used herein, refers to a condition associated with a biological system, for example the state of a biological constituent. In some instances, a biological state refers to a condition associated with the occurrence of a set of biological processes of a biological system. Each biological process of a biological system can interact according to some biological mechanism with one or more additional biological processes of the biological system. As the biological processes change relative to each other, a biological state typically also changes. A biological state typically depends on various biological mechanisms by which biological processes interact with one another. A biological state can include, for example, a condition of a nutrient or hormone concentration in plasma, interstitial fluid, intracellular fluid, or cerebrospinal fluid. For example, biological states associated with hypoglycemia and hypoinsulinemia are characterized by conditions of low blood sugar and low blood insulin, respectively. These conditions can be imposed experimentally or can be inherently present in a particular biological system. As another example, a biological state of a neuron can include, for example, a condition in which the neuron is at rest, a condition in which the neuron is firing an action potential, a condition in which the neuron is releasing a neurotransmitter, or a combination of them. As a further example, biological states of a collection of plasma nutrients can include a condition in which a person awakens from an overnight fast, a condition just after a meal, and a condition between meals. As another example, the biological state of a rheumatic joint can include significant cartilage degradation and hyperplasia of inflammatory cells.

A biological state can include a “disease state,” which, as used herein, refers to an abnormal or harmful condition associated with a biological system. A disease state is typically associated with an abnormal or harmful effect of a disease in a biological system. In some instances, a disease state refers to a condition associated with the occurrence of a set of biological processes of a biological system, where the set of biological processes play a role in an abnormal or harmful effect of a disease in the biological system. A disease state can be observed in, for example, a cell, an organ, a tissue, a multi-cellular organism, or a population of multi-cellular organisms. Examples of disease states include conditions associated with asthma, diabetes, obesity, and rheumatoid arthritis.

The term “drug,” as used herein, refers to a compound of any degree of complexity that can affect a biological state, whether by known or unknown biological processes or mechanisms, and whether or not used therapeutically. In some instances, a drug exerts its effects by interacting with a biological constituent, which can be referred to as a therapeutic target of the drug. Examples of drugs include typical small molecules of research or therapeutic interest; naturally-occurring factors such as endocrine, paracrine, or autocrine factors or factors interacting with cell receptors of any type; intracellular factors such as elements of intracellular signaling pathways; factors isolated from other natural sources; pesticides; herbicides; and insecticides. Drugs can also include, for example, agents used in gene therapy like DNA and RNA. Also, antibodies, viruses, bacteria, and bioactive agents produced by bacteria and viruses (e.g., toxins) can be considered as drugs. For certain applications, a drug can include a composition including a set of drugs or a composition including a set of drugs and a set of excipients.

### C. Virtual Patients

The invention provides multiple virtual patients that can be correlated to a subject. A virtual patient typically comprises a model of one or more biological systems and a parameter set representing a single individual. In the context of the complete system, multiple virtual patients can share a common model. Preferred biological systems for inclusion in a model include, but are not limited to, cardiovascular systems, metabolism, bone, autoimmunity, oncology, respiratory, infection disease, central nervous system, skin, and toxicology.

In one implementation, simulation modeling software is used to provide a computer model, e.g., as described in U.S. Pat. No. 5,657,255, issued Aug. 12, 1997, titled “Hierarchical Biological Modeling System and Method”; U.S. Pat. No. 5,808,918, issued Sep. 15, 1998, titled “Hierarchical Biological Modeling System and Method”; U.S. Pat. No. 6,051,029, issued Apr. 18, 2000, titled “Method of Generating a Display for a Dynamic Simulation Model Utilizing Node and Link Representations”; U.S. Pat. No. 6,539,347, issued Mar. 25, 2003, titled “Method of Generating a Display For a Dynamic Simulation Model Utilizing Node and Link Representations”; U.S. Pat. No. 6,078,739, issued Jan. 25, 2000, titled “A Method of Managing Objects and Parameter Values Associated With the Objects Within a Simulation Model”; and U.S. Pat. No. 6,069,629, issued May 30, 2000, titled “Method of Providing Access to Object Parameters Within a Simulation Model”. An example of simulation modeling software is found in U.S. Pat. No. 6,078,739. Specifically, the modeling software comprises a core, which may be coded using an object-oriented language such as the C++ or Java programming languages. Accordingly, the core is shown to comprise classes of objects, namely diagram objects, access panel objects, layer panel objects, monitor panel objects, chart objects, configuration objects, experiment protocol objects, and measurement objects. As is well known within the art, each object within the core may comprise a collection of parameters (also commonly referred to as instances, variables or fields) and a collection of methods that utilize the parameters of the relevant object.

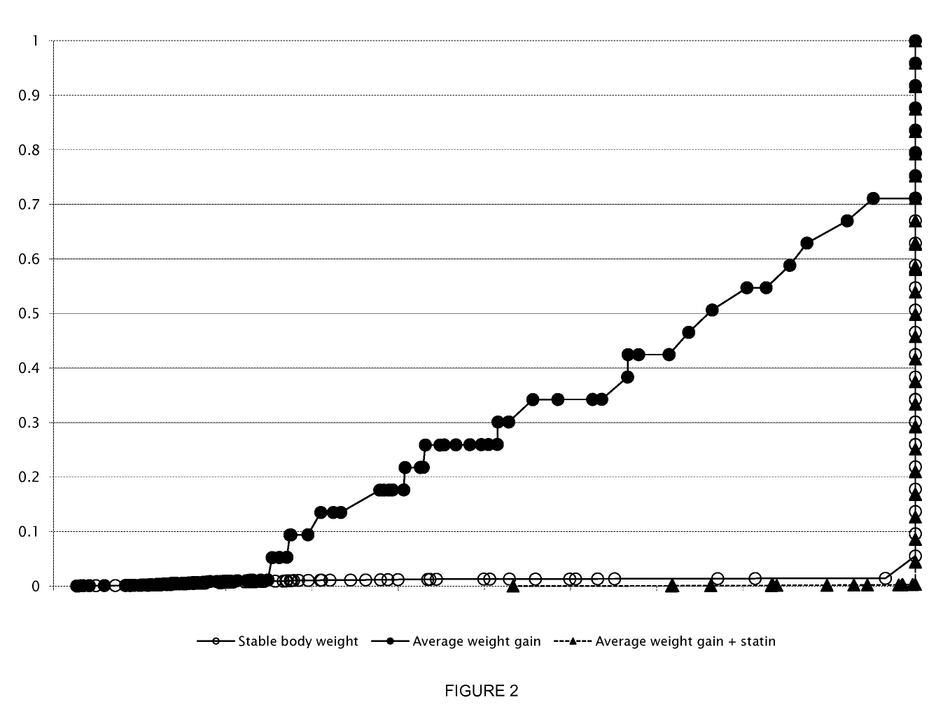

A diagram object can include documentation that provides a description of the diagram object, a collection of parameters, and methods which may define an equation or class or equations. The diagram objects each define a feature or object of a modeled system that is displayed within a diagram window presented by a graphical user interface (GUI) that interacts with the core. An illustration of exemplary modeling software can be found in FIG. 2 of U.S. Patent Publication No. 2005-0131663 and the discussion thereof, incorporated herein by reference.

According to one implementation, the diagram objects may include state, function, modifier and link objects, which are represented respectively by state nodes, function nodes, modifier icons and link icons within the diagram window. Each object defined within the software core can have at least one parameter associated therewith which quantifies certain characteristics of the object, and which is used during simulation of the modeled system. It will also be appreciated that not all objects must include a parameter. In one implementation, several types of parameters are defined. Firstly, system parameters may be defined for each subject type. For example, a system parameter may be assigned an initial value for a state object, or a coefficient value for a link object. Other parameter types include object parameters and diagram parameters that facilitate easy manipulation of values in simulation operations.

The simulation modeling software described above may be used to generate a model for a complex system, such as one or more biological systems. In such a case, the simulation model may include hundreds or even thousands of objects, each of which may include a number of parameters. In order to perform effective “what-if” analyses using a simulation model, it is useful to access and observe the input values of certain key parameters prior to performance of a simulation operation, and also possibly to observe output values for these key parameters at the conclusion of such an operation. As many parameters are included in the expression of, and are affected by, a relationship between two objects, a modeler may also need to examine certain parameters at either end of such a relationship. For example, a modeler may wish to examine parameters that specify the effects a specific object has on a number of other objects, and also parameters that specify the effects of these other objects upon the specific object. Complex models are also often broken down into a system of sub-models, either using software features or merely by the modeler's convention. It is accordingly often useful for the modeler simultaneously to view selected parameters contained within a specific sub-model. The satisfaction of this need is complicated by the fact that the boundaries of a sub-model may not be mutually exclusive with respect to parameters, i.e., a single parameter may appear in many sub-models. Further, the boundaries of sub-models often change as the model evolves.

A computer model can be designed to model one or more biological processes or functions. The computer model can be built using a “top-down” approach that begins by defining a general set of behaviors indicative of a biological condition, e.g. a disease. The behaviors are then used as constraints on the system and a set of nested subsystems are developed to define the next level of underlying detail. For example, given a behavior such as cartilage degradation in rheumatoid arthritis, the specific mechanisms inducing the behavior are each be modeled in turn, yielding a set of subsystems, which can themselves be deconstructed and modeled in detail. The control and context of these subsystems is, therefore, already defined by the behaviors that characterize the dynamics of the system as a whole. The deconstruction process continues modeling more and more biology, from the top down, until there is enough detail to replicate a given biological behavior. Specifically, the model is capable of modeling biological processes that can be manipulated by a drug or other therapeutic agent.

In some instances, the computer model can define a mathematical model that represents a set of biological processes of a physiological system using a set of mathematical relations. For example, the computer model can represent a first biological process using a first mathematical relation and a second biological process using a second mathematical relation. A mathematical relation typically includes one or more variables, the behavior (e.g., time evolution) of which can be simulated by the computer model. More particularly, mathematical relations of the computer model can define interactions among variables, where the variables can represent levels or activities of various biological constituents of the physiological system as well as levels or activities of combinations or aggregate representations of the various biological constituents. A biological constituent that makes up a physiological system can include, for example, an extracellular constituent, a cellular constituent, an intracellular constituent, or a combination thereof. Examples of biological constituents include nucleic acids (e.g. DNA; RNA); proteins; enzymes; hormones; cells; organs; tissues; portions of cells, tissues, or organs; subcellular organelles such as mitochondria, nuclei, Golgi complexes, lysosomes, endoplasmic reticula, and ribosomes; chemically reactive molecules such as H+ superoxides, ATP, citric acid; and combinations thereof. In addition, variables can represent various stimuli that can be applied to the physiological system.

A computer model typically includes a set of parameters that affect the behavior of the variables included in the computer model. For example, the parameters represent initial values of variables, half-lives of variables, rate constants, conversion ratios, and exponents. These variables typically admit a range of values, due to variability in experimental systems. Specific values are chosen to give constituent and system behaviors consistent with known constraints. Thus, the behavior of a variable in the computer model changes over time. The computer model includes the set of parameters in the mathematical relations. In one implementation, the parameters are used to represent intrinsic characteristics (e.g., genetic factors) as well as external characteristics (e.g., environmental factors) for a biological system.

Mathematical relations used in a computer model can include, for example, ordinary differential equations, partial differential equations, stochastic differential equations, differential algebraic equations, difference equations, cellular automata, coupled maps, equations of networks of Boolean, fuzzy logic networks, or a combination of them.

Running the computer model produces a set of outputs for a biological system represented by the computer model. The set of outputs represent one or more biological states of the biological system, i.e., the simulated subject, and includes values or other indicia associated with variables and parameters at a particular time and for a particular execution scenario. For example, a biological state is represented by values at a particular time. The behavior of the variables is simulated by, for example, numerical or analytical integration of one or more mathematical relations produce values for the variables at various times and hence the evolution of the biological state over time.

In one implementation, the computer model can represent a normal state as well as a disease state of a biological system. For example, the computer model includes parameters that are altered to simulate a disease state or a progression towards the disease state. The parameter changes to represent a disease state are typically modifications of the underlying biological processes involved in a disease state, for example, to represent the genetic or environmental effects of the disease on the underlying physiology. By selecting and altering one or more parameters, a user modifies a normal state and induces a disease state of interest. In one implementation, selecting or altering one or more parameters is performed automatically.

The created computer model represents biological processes at multiple levels and then evaluates the effect of the biological processes on biological processes across all levels. Thus, the created computer model provides a multi-variable view of a biological system. The created computer model also provides cross-disciplinary observations through synthesis of information from two or more disciplines into a single computer model or through linking two computer models that represent different disciplines.

An exemplary, computer model reflects a particular biological system and anatomical factors relevant to issues to be explored by the computer model. The level of detail incorporated into the model is often dictated by a particular intended use of the computer model. For example, biological constituents being evaluated often operate at a subcellular level; therefore, the subcellular level can occupy the lowest level of detail represented in the model. The subcellular level includes, for example, biological constituents such as DNA, mRNA, proteins, chemically reactive molecules, and subcellular organelles. Similarly, the model can be evaluated at the multicellular level or even at the level of a whole organism. Because an individual biological system, i.e. a single human, is a common entity of interest with respect to the ultimate effect of the biological constituents, the individual biological system (e.g., represented in the form of clinical outcomes) is the highest level represented in the system. Disease processes and therapeutic interventions are introduced into the model through changes in parameters at lower levels, with clinical outcomes being changed as a result of those lower level changes, as opposed to representing disease effects by directly changing the clinical outcome variables.

In one implementation, the computer model is configured to allow visual representation of mathematical relations as well as interrelationships between variables, parameters, and biological processes. This visual representation includes multiple modules or functional areas that, when grouped together, represent a large complex model of a biological system.

In one implementation, the computer model includes one or more virtual patients. Various virtual patients of the computer model are associated with different representations of a biological system. In particular, various virtual patients of the computer model represent, for example, different variations of the biological system having different intrinsic characteristics, different external characteristics, or both. An observable condition (e.g., an outward manifestation) of a biological system is referred to as its phenotype, while underlying conditions of the biological system that give rise to the phenotype can be based on genetic factors, environmental factors, or both. Phenotypes of a biological system are defined with varying degrees of specificity. In some instances, a phenotype includes an outward manifestation associated with a disease state. A particular phenotype typically is reproduced by different underlying conditions (e.g., different combinations of genetic and environmental factors). For example, two human patients may appear to be similarly arthritic, but one can be arthritic because of genetic susceptibility, while the other can be arthritic because of diet and lifestyle choices. Exemplary models of biological systems include commercially available computer models: Entelos® Asthma PhysioLab® systems, Entelos® Metabolism PhysioLab® systems, and Entelos® Rheumatoid Arthritis PhysioLab® systems.

Example publications describing the generation or manipulation of virtual patients include U.S. Pat. No. 6,078,739; U.S. Pat. No. 7,165,017; and “Apparatus and Method for Validating a Computer Model”, (U.S. application Publication No. 20020193979, published on Dec. 19, 2002). Once various virtual patients are created, execution of a computer model can produce various sets of outputs, and correlation analysis can be performed on the sets of outputs to identify biomarkers. For example, correlation analysis can be performed on the sets of outputs to identify a set of outputs at an earlier point in time that can serve to predict or infer efficacy of a therapeutic regimen at a subsequent point in time.

For certain applications, various configurations of the computer model can be referred to as virtual patients. A virtual patient can be defined to represent a human subject having a phenotype based on a particular combination of underlying conditions. Various virtual patients can be defined to represent human subjects having the same phenotype but based on different underlying conditions. Alternatively, or in conjunction, various virtual patients can be defined to represent human subjects having different phenotypes.

One or more virtual patients in conjunction with the computer model can be created based on an initial virtual patient that is associated with initial parameter values. A different virtual patient can be created based on the initial virtual patient by introducing a modification to the initial virtual patient. Such modification can include, for example, a parametric change (e.g., altering or specifying one or more initial parameter values), altering or specifying behavior of one or more variables, altering or specifying one or more functions representing interactions among variables, or a combination thereof. For instance, once the initial virtual patient is defined, other virtual patients may be created based on the initial virtual patient by starting with the initial parameter values and altering one or more of the initial parameter values. Alternative parameter values can be defined as, for example, disclosed in U.S. Pat. No. 6,078,739. These alternative parameter values can be grouped into different sets of parameter values that can be used to define different virtual patients of the computer model. For certain applications, the initial virtual patient itself can be created based on another virtual patient (e.g., a different initial virtual patient) in a manner as discussed above.

Alternatively, or in conjunction, one or more virtual patients in the computer model can be created based on an initial virtual patient using linked simulation operations as, for example, disclosed in U.S. Pat. Nos. 6,983,237 and 7,165,017. These patents discloses a method for performing additional simulation operations based on an initial simulation operation where, for example, a modification to the initial simulation operation at one or more times is introduced. In the present embodiment of the invention, such additional simulation operations can be used to create additional virtual patients in the computer model based on an initial virtual patient that is created using the initial simulation operation. In particular, a virtual patient can be customized to represent a particular subject. If desired, one or more simulation operations may be performed for a time sufficient to create one or more “stable” virtual patient of the computer model. Typically, a “stable” virtual patient is characterized by one or more variables under or substantially approaching equilibrium or steady-state condition.

Various virtual patients of the computer model can represent variations of the biological system that are sufficiently different to evaluate the effect of such variations on how the biological system responds to a given therapy. In particular, one or more biological processes represented by the computer model can be identified as playing a role in modulating biological response to the therapy, and various virtual patients can be defined to represent different modifications of the one or more biological processes. The identification of the one or more biological processes can be based on, for example, experimental or clinical data, scientific literature, genetic studies, results of a computer model, model sensitivity analysis, or a combination of them. Once the one or more biological processes at issue have been identified, various virtual patients can be created by defining different modifications to one or more mathematical relations included in the computer model, which one or more mathematical relations represent the one or more biological processes. A modification to a mathematical relation can include, for example, a parametric change (e.g., altering or specifying one or more parameter values associated with the mathematical relation), altering or specifying behavior of one or more variables associated with the mathematical relation, altering or specifying one or more functions associated with the mathematical relation, or a combination of them. The computer model may be run based on a particular modification for a time sufficient to create a “stable” configuration of the computer model.

A collection of virtual patients, i.e. a virtual population, ideally is representative of a real population. If a sample population of real subjects is representative of the population, then the collection of virtual patients representing that sample population should be similar to the sample of real subjects from the population. For example, a collection of virtual patients has virtual patients that approximate the phenotypes observed in the sample population. In addition, the weighted frequency of each virtual patient in the virtual patient population is similar to the frequency of the corresponding real subject in the sample and, in this case, in the clinical population. The assignment of weighted frequencies to virtual patients is described in greater detail in U.S. patent publication no. 2007-00265365, entitled “Defining Virtual Patient Populations,” incorporated herein by reference in its entirety.

A virtual patient population is typically intended to be representative of the population with respect to at least some features of the population. Whether the virtual patient population is representative of the real population is typically indicated by some evaluation of similarity, for example, by comparing the distribution of values or summary statistics for that feature in the virtual patient population and the real population.

A collection of virtual patients is representative of the population when statistics describing the virtual patients are similar to the same statistics describing the subjects in the real population. For example, the mean and variance of one or more population characteristics of the virtual patients is preferably similar to the mean and variance of the same one or more population characteristics in the sample population of real subjects. Also for example, where each of several virtual patients is comparable to a collection of real subjects, the frequency of each virtual patient in a virtual patient population is preferably similar to the frequency of each of the corresponding sets of real subjects in the population.

### D. Selecting One or More Virtual Patients

Data for real subjects in a sample population and virtual measures for each of two or more virtual patients can, for example, represent independent or dependent variables. Independent variables describe features whose values are typically set or known for a particular individual; whereas dependent variables describe features whose values causally depend, whether actually or hypothetically, upon the values of the independent variables. Data or measures for independent variables can represent the demographics and physiologic state variables of the population and related subpopulations. For example, independent variables can describe features such as blocking factors (e.g. gender, ages, disease state, body weight, body mass index), and initial physiological measures (e.g. “initial triglyceride concentration”). The values of the dependent variables typically characterize the state of a particular virtual patient or real subject, and can be used to answer a question about a possible relationship with the independent variables. Data or measures of dependent variables represent, for example, physiological features that depend on environmental features, or the result of the intervention (e.g., drug therapy).

To evaluate the similarity of the virtual patients to the real subjects, it may be useful to account for variability in the features of the virtual patients and the real subjects. For example, cross-sectional data can be used to estimate variability among features of interest of virtual patients or real subjects and longitudinal data can be used to estimate within-patient and within-subject variability in features of interest, including for example the shape or dynamics of a temporal trajectory. Features of interest include those that can be characterized by dependent variables and independent variables. Independent variables that may account for variability in the dependent variables can be identified and used to reduce confounding variability in the dependent variables and permit the identification of causal relationships of interest. For example, categorical variables such as gender, age group, and disease group; and continuous variables such as genetic susceptibility, age, and disease indicator can be used to help account for variability in the dependent variables.

To evaluate similarity or correlation, a measure of goodness-of-fit between the common features for the virtual patients and the common features for the real subjects can be calculated. A measure of goodness-of-fit between the combinations of the common features for the virtual patients and the combinations of the common features for the real subjects can be calculated. The measure of goodness-of-fit can be a Chi-square test, G-test, Analysis of Covariance (ANCOVA), Kolmogorov-Smimov test, weighted coefficient of determination. The measure of goodness-of-fit can be a qualitative assessment of statistical properties of the common features for the virtual patients and the common features for the real subjects. A detailed description of methods for matching virtual patients to real subjects can be found in U.S. Patent Application Publication No. 2005-0131663, incorporated herein by reference in it entirety.

Common features can include at least one continuous dependent variable and similarity can be evaluated by calculating one or more summary statistics for the continuous dependent variable for the real subjects, calculating the one or more summary statistics for the continuous dependent variable for the virtual patients according to their respective prevalences, and comparing the one or more summary statistics for the real subjects with the summary statistics for the virtual patients.

Based upon the similarity between the features of the real subject and the virtual patients within the prevalence-weighted virtual population, certain virtual patients can be selected form the population that most closely represent, i.e., are most similar to, the real subject. For example, for univariate cross-sectional data and measures of a dependent variable, similarity between the features of the real subjects and the virtual patients can be evaluated by comparing the mean value of the feature for the real subjects with the mean value of the feature for the virtual patient population. Alternatively or in addition, similarity between the features of the real subjects and the virtual patients can be evaluated by comparing the mode, standard deviation, variance, skewness, or kurtosis of the feature for the real subjects with the mode, standard deviation, variance, skewness, or kurtosis, respectively, of the feature for the virtual patients. For multivariate data and measures of a dependent variable, similarity between the features of the real subjects and the virtual patients can be evaluated by comparing the mean values of the features for the real subjects with the mean values of the features for the virtual patients, as discussed above for univariate data. For example, a vector containing mean % body fat and mean fasting insulin levels of the real subjects can be compare to a vector containing mean % body fat and mean fasting insulin levels of the virtual patients.

In certain implementations of the invention, the virtual patients that most closely represent the real subject can be identified by (a) collecting data about the subject; (b) create a filter based on the subject's data; and (c) applying the filter to each virtual patient in a virtual population, wherein the filter identifies those virtual patients most closely representing the subject. The data collected from the subject can include physical data (such as height, weight or blood serum levels), genetic data (such as gender or genetic profile), environmental data (such as chemical exposure or location of residence) and lifestyle data (such as exercise regimen or diet). The data about the subject can be collected from manual entry, directly from devices or diagnostic equipment, or from an electronic data store such as an electronic medical record or personal health record system. In certain implementations, the filter created based on the subject's data can be a standard deviation or other representation of noise in the measurements to create a filter that has a range of values rather than requiring the virtual patient to match an absolute value.

### E. Simulating Clinical Outcomes

One aspect of the invention provides computer-implemented methods of predicting a clinical outcome for a subject comprising: (a) providing a virtual population comprising a plurality of virtual patients; (b) receiving input data about a subject; (c) selecting one or more virtual patients from the virtual population based on a similarity between each of the selected virtual patients and the input data; (d) applying one or more virtual protocols to the one or more selected virtual patients to generate a set of outputs projecting a clinical outcome for the subject, wherein a set of outputs is generated for each selected virtual patient; and (e) reporting the set of outputs to a user. In certain implementations, each virtual patient of the virtual population has an associated prevalence. In such cases, applying one or more virtual protocols to the one or more selected virtual patients can comprise calculating a likelihood of each clinical outcome based upon the prevalence of the one or more virtual patients. The set of output can comprise the likelihood of each clinical outcome or the likelihood of a selected set of clinical outcomes, for example the most likely outcomes or a subset of outcomes representative of the range of clinical outcomes. In certain implementations, the virtual population is a prevalence-weighted virtual population, wherein each virtual patient of the virtual population has an associated prevalence weight. In a preferred implementation, the virtual protocol represents a stimulus selected from the group consisting of a therapeutic regimen, passage of time, exercise, weight gain, diet, a lifestyle choice and a combination of two or more of the same.

Once one or more virtual patients are identified, potential clinical outcomes can be generated by applying one or more virtual protocols to the computer model. The resulting simulation produces a set of outputs for a biological system represented by the computer model. The set of outputs represent one or more biological states of the biological system, i.e., the simulated subject, and includes values or other indicia associated with variables and parameters at a particular time and for a particular execution scenario. For example, a biological state is represented by values at a particular time. The behavior of the variables is simulated by, for example, numerical or analytical integration of one or more mathematical relations produce values for the variables at various times and hence the evolution of the biological state over time.

An experimental protocol, e.g., a virtual therapy, representing an actual therapy can be applied to a virtual patient to predict how the real subject linked to that virtual patient would respond to the therapy. Experimental protocols that can be applied to a biological system can include, for example, existing or hypothesized therapeutic agents and treatment regimens, mere passage of time, exposure to environmental toxins, change in diet, increased exercise, compliance to medication, and the like. By applying an experimental protocol to a virtual patient, a set of results of the experimental protocol can be produced, which can be indicative of various effects of a therapy.

For certain applications, an experimental protocol can be created in a manner similar to that used to create a stimulus-response test. For certain applications, a virtual stimulus may be referred to as a stimulus-response test. By applying a set of stimulus-response tests to a virtual patient in the computer model, a set of results of the set of stimulus-response tests can be produced. The virtual patient can be validated if the set of results of the set of stimulus-response tests sufficiently conforms to a set of expected results of the set of stimulus-response tests. An expected result of a stimulus-response test can be based on actual, predicted, or desired behavior of a biological system when subjected to a stimulus associated with the stimulus-response test. When validating one or more virtual patients in the computer model with respect to a phenotype of the biological system, an expected result of a stimulus-response test typically will be based on actual, predicted, or desired behavior for the phenotype of the biological system. The behavior of a biological system can be, for example, an aggregate behavior of the biological system or behavior of a portion of the biological system when subjected to a particular stimulus. By way of example, an expected result of a stimulus-response test can be based on experimental or clinical behavior of a biological system when subjected to a stimulus associated with the stimulus-response test. For certain applications, an expected result of a stimulus-response test can include an expected range of behavior associated with a biological system when subjected to a particular stimulus. Such range of behavior can arise, for example, as a result of variations of the biological system having different intrinsic properties, different external influences, or both.

A stimulus-response test can be created by defining a modification to one or more mathematical relations included in the computer model, which one or more mathematical relations can represent one or more biological processes affected by a stimulus associated with the stimulus-response test. A stimulus-response test can define a modification that is to be introduced statically, dynamically, or a combination of them, depending on the type of stimulus associated with the stimulus-response test. For example, a modification can be introduced statically by replacing one or more parameter values with one or more modified parameter values associated with a stimulus. Alternatively, or in conjunction, a modification can be introduced dynamically to simulate a stimulus that is applied in a time-varying manner (e.g., a stepwise manner or a periodic manner or toxin). For instance, a modification can be introduced dynamically by altering or specifying parameter values at certain times or for a certain time duration.

For certain applications, a stimulus-response test can be applied to one or more configurations of the computer model using linked simulation operations as discussed previously. For instance, an initial simulation operation may be performed for a virtual patient, and, following introduction of a modification defined by a stimulus-response test, one or more additional simulation operations that are linked to the initial simulation operation may be performed for the virtual patient.

Thus, an experimental protocol can be created, for example, by defining a modification to one or more mathematical relations included in a model, which one or more mathematical relations can represent one or more biological processes affected by a condition or effect associated with the experimental protocol. An experimental protocol can define a modification that is to be introduced statically, dynamically, or a combination thereof, depending on the particular conditions and/or effects associated with the experimental protocol.

In the present embodiment of the invention, a set of virtual measurements can be defined such that a set of results of an experimental protocol can be produced for a particular virtual patient. Multiple virtual measurements can be defined, and a result can be produced for each of the virtual measurements. A virtual measurement can be associated with a measurement for a biological system, and different virtual measurements can be associated with measurements that differ in some fashion from one another.

### F. Incorporating Genetic Information

Another aspect of the invention provides methods for modifying a computer model of a biological system to reflect genomic information, the method comprising: (a) providing a computer model of a biological system in a computer-readable storage medium; (b) providing a genetic marker having a known association with a clinical phenotype, wherein the genetic marker has a known locus on a chromosome; (c) identifying one or more genes of known biological function that have linkage disequilibrium with the locus of the genetic marker; (d) modifying the computer model to reflect the function of the one or more identified genes; and (e) storing the modified computer model in a computer-readable storage medium. The computer model can be modified to directly reflect the function of the one or more identified genes, to directly reflect absence of the function of the one or more identified genes or to indirectly reflect the downstream function of the one or more identified genes. In certain implementations, the method can further comprise (f) executing the modified computer model to generate a simulated outcome; and (g) comparing the simulated outcome with the known association between the genetic marker and clinical phenotype to confirm the validity of the modified computer model. In such a case, comparing the simulated outcome with the known associate between the genetic marker and clinical phenotype optionally can comprise comparing a virtual population with a clinical population.

Information about a genetic marker can also be incorporated into a virtual population. Therefore, another aspect of the invention provides methods of incorporating a genetic marker into a virtual population, said method comprising: (a) providing an original virtual population having a set of population constraints; (b) defining the effect of the genetic marker as one or more new axes of variation to be included in generating a new virtual population; (c) generating virtual patients based on (i) the population constraints of the original virtual population and (ii) the one or more new axes of variation; (d) assigning prevalence weights to the virtual population, incorporating population statistics for the genetic marker as a constraint in the prevalence weighting process; and (e) generating an output comprising the virtual population and associated prevalence weights. In certain implementations, the virtual population is provided as data stored on a computer readable medium. In some implementations, each allele for the genetic marker corresponds to a different quantitative position on the new axis of variation. The effect of the genetic marker can be defined as a single new axis of variation or as more than one new axis of variation. In certain implementations, defining the effect of the genetic marker as one or more new axes of variation comprises:(i) identifying the locus of the genetic marker on a chromosome; (ii) identifying one or more genes of known biological function that have linkage disequilibrium with the locus of the genetic marker; and (iii) defining the one or more new axes of variation based upon the known biological function of the one or more genes. the one or more axes of variation can directly reflect the function of the one or more identified genes, directly reflect the absence of the function of the one or more identified genes, or reflect a downstream effect of the function of the one or more identified genes.

A genetic marker is a nucleic acid sequence (typically a DNA sequence) that can be described as an observable variation, and which may arise due to mutation or alteration in the genomic loci. In certain implementations, the genetic marker can be a single nucleotide polymorphism (SNP), a short tandem repeat, a single feature polymorphism, a restriction fragment length polymorphism, an amplified fragment polymorphism, a random amplification polymorphism, a variable number tandem repeat or a microsatellite polymorphism. Preferably, the genetic marker is a single nucleotide polymorphism. For the present invention, the genetic marker has a known association with a clinical phenotype. The clinical phenotype can be any observable phenomenon such as susceptibility to developing a disorder, or rate of progression of a disorder. A genetic marker of interest can be selected by its association with a clinical outcome of interest, as well as a measure of the genetic marker's significance. A genetic marker's significance can be measured by population attributable risk (PAR) and odds ratios (OR). Preferably, the chromosomal location of the genetic marker is known.

Once a genetic marker is selected, one or more genes of known biological function that have linkage disequilibrium with the locus of the genetic marker can be identified. Linkage disequilibrium describes a situation in which some combinations of alleles or genetic markers occur more or less frequently in a population than would be expected from a random formation of haplotypes from alleles based on their frequencies. Genes having linkage disequilibrium with the locus of the genetic marker can be identified by close proximity to the genetic marker.

The computer model can then be modified based upon the function of the genes identified as having linkage disequilibrium. The computer model can be modified to directly reflect the function of the one or more identified genes to directly reflect absence of the function of the one or more identified genes or to reflect a downstream effect of the function of the one or more identified genes. Any reasonable hypothesis linking the known function of the identified gene to the clinical phenotype associated with the genetic marker can be the basis of the modification to the computer model.

In certain implementations, the computer model is modified by altering parameter values in those sections of the model related to the physiology of the disease. If the physiology of interest is not already directly represented within the computer model, then the physiology of interest can be indirectly modulated, or the physiology in the model may be expanded to include a more direct representation. An example of indirect modulation of physiology includes, but is not limited to decreased sensitivity of cellular phenotype to a soluble mediator in order to represent genetic variations in receptor binding, trafficking, or signaling that gives rise to this net physiologic behavior.

The modified computer model can be validated by executing the modified computer model to generate a simulated outcome. A modified computer model can be validated when the simulate outcome is substantially consistent with the disease outcomes known to be associated with the SNP. In the case that multiple modifications are made to the model based on more than one gene having linkage disequilibrium with the genetic marker, the modification and validation preferably is repeated for each gene separately.

In another aspect of the invention, the effect(s) of a genetic marker can be incorporated into a virtual population by: (a) add the effect of the genetic marker as a new axis of variation to be included in generating the population; (b) generating virtual patients with the genetic effect variations and confirming that the generated virtual patients are consistent with other data; (c) assigning prevalence weights to the virtual population, incorporating the population statistics for the genetic marker as a new constraint in the prevalence weighting process.

When adding the effect of the genetic marker as a new axis of variation, preferably each allele for the genetic marker corresponds to a different quantitative position on the effect axis of variation. Each allele of the genetic marker can be mapped on to one or more axes of variation. In cases, where the functional effect of a genetic marker is well understood, the genetic marker may map to a single axis of variation. In cases where the functional effect of the genetic marker is poorly understood or cannot be directly included into the computer model, the genetic marker may map on to several axes of variation.

Constraints based upon population statistics (i.e. population constraints) can include both the incidence of the different alleles and population statistics for outcomes and biomarkers associated with each allele. Preferably each allele for the genetic marker has associated population statistics for both the incidence of the alleles (including correlations or the lack thereof with other markers) and odds ratios for outcomes or other physiologic measures. In certain implementations of the invention, prevalence-weighted simulation results using the virtual population will generate statistics consistent with population and other constraints.

A specific implementation of the invention relates to predicting cardiovascular risk based on genetic marker status as exemplified in Example 1, below. Thus one aspect of the invention provides methods for predicting cardiovascular risk based a genetic marker status, the method comprising: (a) identifying a genetic marker status or a subject; (b) providing a computer model of cardiovascular risk configured to account for the genetic marker, wherein the computer model comprises: (i) a representation of cholesterol metabolism, (ii) a representation of atherogenesis, and (iii) a representation of plaque stability, wherein a positive genetic marker status is indicated by an alteration in at least one of cholesterol metabolism, atherogenesis and plaque stability; and (c) simulating and reporting an outcome for the subject. In certain implementations, the genetic marker is a single nucleotide polymorphism (SNP), preferably located at chromosomal locus 9p21, and more preferably is rs10757278(G). In such an implementation, a positive genetic marker status can be indicated by increased smooth muscle cell apoptosis and decreased smooth muscle cell proliferation in a plaque. In certain implementations, the computer model of cardiovascular risk further can be configured to account for imaging data about a subject, wherein the imaging data is indicated in the model by an alteration of at least one of cholesterol metabolism, atherogenesis and plaque stability. In other implementations, the computer model of cardiovascular risk further can be configured to account for a blood measurement about a subject, wherein the blood measurement is indicated in the model by an alteration of at least one of cholesterol metabolism, atherogenesis and plaque stability.

### G. Computer Implementation

This invention can include a single computer model that serves a number of purposes. Alternatively, this layer can include a set of large-scale computer models covering a broad range of physiological systems. Examples of large-scale computer models are listed below. In addition, the system can include complementary computer models, such as, for example, epidemiological computer models and pathogen computer models. For use in healthcare, computer models can be designed to analyze a large number of subjects and therapies. In some instances, the computer models can be used to create a large number of validated virtual patients and to simulate their responses to a large number of therapies.

Underlying the large-scale computer models can be computer models of key physiological systems that may be shared across the large-scale computer models. Examples of such physiological systems include the immune system and the inflammatory system, as described, e.g., in U.S. Pat. No. 7,353,152, titled “Method and Apparatus for Computer Modeling Diabetes”; U.S. Pat. No. 6,862,561, titled “Method and Apparatus for Computer Modeling a Joint”; and in the following published U.S. patent applications: US 2003/0104475, published Jun. 5, 2003, titled “Method and Apparatus for Computer Modeling of an Adaptive Immune Response”; US 2006/0195308, published 31 Aug. 2006, entitled “Methods and Models for Cholesterol Metabolism;” US 2007/0071681, published 29 Mar. 2007, entitled “Apparatus and Method for Computer Modeling Type 1 Diabetes;” US 2008/0028695, published 31 Jan. 2008, entitled “Apparatus and Method for Computer Modeling Respiratory Disease;” and US 2008/0259751, published 9 Oct. 2008, entitled “Method and Apparatus for Modeling Atherosclerosis.” These underlying computer models may also be directly accessed for cross-disease research.

A computer model can be run to produce a set of outputs or results for a physiological system represented by the computer model. The set of outputs can represent a biological state of the physiological system, and can include values or other indicia associated with variables and parameters at a particular time and for a particular execution scenario. For example, a biological state can be mathematically represented by values at a particular time. The behavior of variables can be simulated by, for example, numerical or analytical integration of one or more mathematical relations. For example, numerical integration of the ordinary differential equations defined above can be performed to obtain values for the variables at various times and hence the evolution of the biological state over time. The output can also describe one or more individuals in a virtual population or characteristics about these one or more individuals.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

In certain implementations, the system of the invention comprises a computer readable storage medium storing a plurality of variables, parameters and/or mathematical representations that comprise a computer model of a biological system. The computer readable storage medium also can comprises a plurality of variable and/or parameters representing one or more virtual patients. In the case that the computer readable storage medium comprises a plurality of variables and/or parameters representing more than one virtual patient, the computer readable medium can also comprise a plurality of variables and/or parameters representing population characteristics of each of the virtual patients and of the virtual population as a whole.

The programmable processor, responsive to a request from a user interface to execute the computer model, retrieves at least a subset of variables, parameters and/or mathematical representations from the computer readable storage medium and applies the mathematical representations to the variables and parameters to generate a simulated effect. The processor can further retrieve and apply various parameters or variables in the context of the mathematical representations to represent one or more virtual protocols in accordance with the invention described above.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

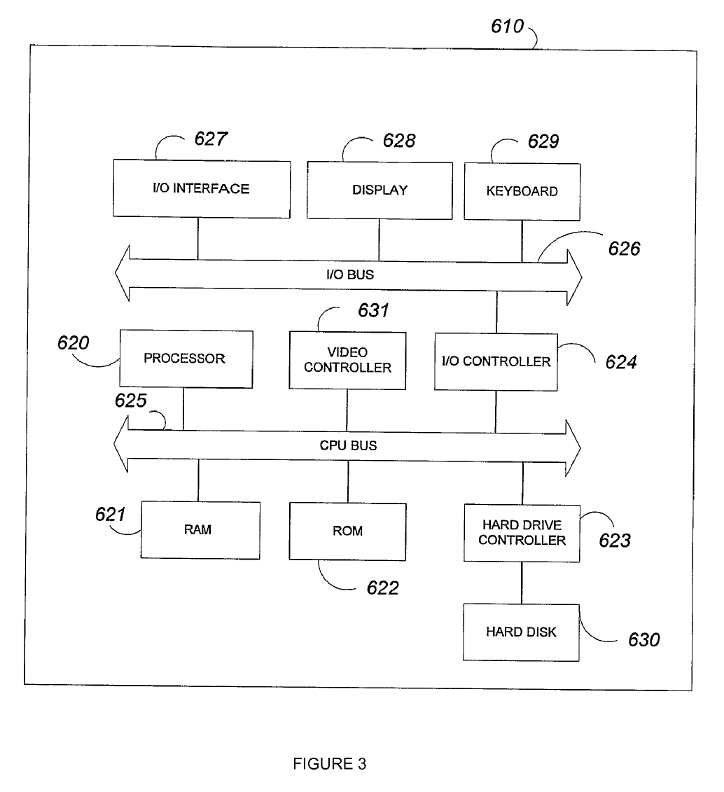

An example of one such type of computer is shown in FIG. 3, which shows a block diagram of a programmable processing system (system) 610 suitable for implementing or performing the apparatus or methods of the invention. The system 610 includes a processor 620, a random access memory (RAM) 621, a program memory 622 (for example, a writable read-only memory (ROM) such as a flash ROM), a hard drive controller 623, a video controller 631, and an input/output (I/O) controller 624 coupled by a processor (CPU) bus 625. The system 610 can be preprogrammed, in ROM, for example, or it can be programmed (and reprogrammed) by loading a program from another source (for example, from a floppy disk, a CD-ROM, or another computer).

The hard drive controller 623 is coupled to a hard disk 630 suitable for storing executable computer programs, including programs embodying the present invention, and data.

The I/O controller 624 is coupled by means of an I/O bus 626 to an I/O interface 627. The I/O interface 627 receives and transmits data (e.g., stills, pictures, movies, and animations for importing into a composition) in analog or digital form over communication links such as a serial link, local area network, wireless link, and parallel link.

Also coupled to the I/O bus 626 is a display 628 and a keyboard 629. Alternatively, separate connections (separate buses) can be used for the I/O interface 627, display 628 and keyboard 629.

### VI. EXAMPLES

The following examples are provided to illustrate embodiments of the invention as described herein and are not intended to limit the scope of the invention in any way.

### A. Example 1

Recently, a common sequence variant located on chromosome 9p21 has been identified as associated with an increased risk of myocardial infarction (Helgadottir, et al., Science, 316:1491-93 (8 Jun. 2007)). While many single nucleotide polymorphisms (SNPs) are known in the vicinity of this variant, one particular SNP, rs10757278 showed the strongest correlation with disease. In particular, carriers of the G allele of SNP rs10757278 are more likely to have a myocardial infarction, with homozygous carriers of rs10757278(G) being 1.64 times as likely to experience Ml than a non-carrier. Heterozygous carriers are 1.24 times more likely to have an MI than non-carriers. Approximately one-quarter of the general population is homozygous for rs10757278(G) and approximately one-half of the population is heterozygous for this variant.

rs10757278(G) is located on chromosome 9p21 in an LD block that contains the CDKN2A and CDKN2B genes, also known as p₁₅^{INK4b} and p₁₆^{INK4a} (hereinafter referred to as “p15/p16”). While Helgadottir, et al. noted the proximity of p15/p16 to the rs10757278 locus, they could find no evidence of any functional variant in p15/p16 that could account for observed association of rs10757278 with increased risk of MI. The linkage disequilibrium (LD) block containing rs10757729 includes, in addition to p15/p16, two exons of the mRNA transcript AF109294, a hypothetical methylthioadenosine phosphorylase fusion protein and several expressed sequence tags that are expressed in various tissues (Helgadottir, et al., Supplementary Table 10). The present invention provides evidence that p15/p16 function is, in fact, relevant to the increased risk of myocardial infarction.

The tumor suppressor genes, p15/p16, are located approximately 5000 bp from the rs10757278 locus. p15/p16 are known to play a critical role in regulating cell proliferation, cell aging, senescence and apoptosis. Indeed, p15/p16 function is well known to function in cancer, particularly malignant melanoma. Variants at 9p21 were previously known to identified as tumor suppressors (Gil and Peters, Nature Reviews:Molecular Cell Biology 7:667-77 (2006) and Kim and Sharpless, Cell 127:265-75 (2006)). Specifically, an increase in p15/p16 decreases cell proliferation and increases cell senescence.

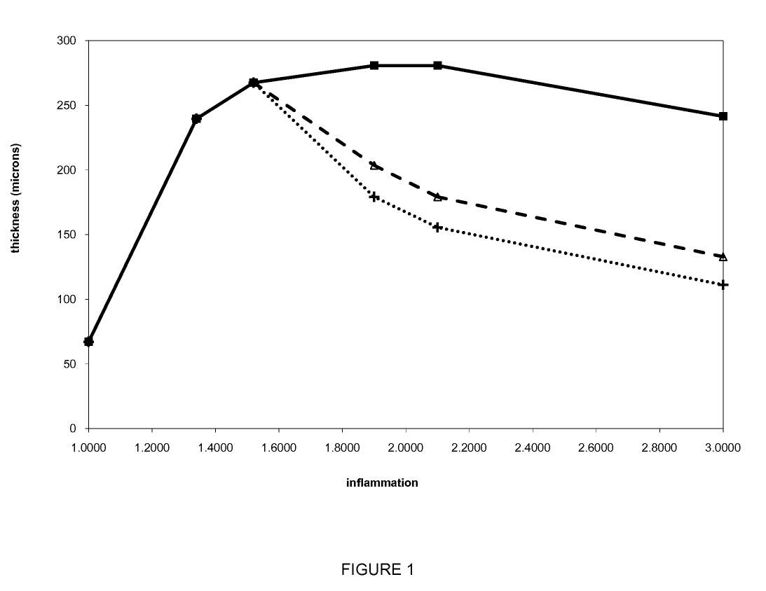

FIG. 1 illustrates the relationship between intimal thickness and a inflammation index reflecting the level of local vessel inflammation for a homozygous non-carrier (solid squares), a heterozygous (open triangles) and homozygous carrier (crosses). A specific illustration of a hypothesis for how p15/p16 activity can change the response of smooth muscle to the inflammatory milieu. This hypothesis was implemented in the computer model of atherosclerosis/cardiovascular risk. When a modification representing this hypothesis was implemented in a virtual population, the resulting virtual population was then consistent with the population statistics related to rs10757278 as well as the existing constraints on the population form other clinical studies.

In order to represent a subject (“Subject A”) homozygous for the rs10757278(G) variant, multiple virtual patients were developed in the context of a computer model of atherosclerosis and cardiovascular risk. A detailed description and illustration of this computer model can be found in co-pending application Ser. No. 11/875,809, filed 19 Oct. 2007 and entitled “Method and Apparatus for Modeling Atherosclerosis,” which application is incorporated by reference herein in its entirety. Virtual patients in the computer model of atherosclerosis were created to incorporate different hypotheses on inflammation on intimal thickness, as embodied in the three curves of FIG. 1.

Table I provides actual patient-specific data describing Subject A in comparison to empirical data from the Atherosclerosis Risk in Communities (ARIC) study and a prevalence-weighted virtual population, The data obtained from Subject A included, inter alia: age, gender, diabetes status, blood pressure, data from a blood sample (including standard lipid panel, lipoprotein particle distribution, inflammatory markers, and glucose metabolism markers), a genetic analysis, and imaging tests results including an ultrasound measuring carotid intima-media thickness (cIMT) and a coronary calcium score determined by CT scan. Lipoprotein particle distribution can be measured by any of a variety of methods known in the art, including but not limited to, Lipoprotein Fractionation by Ion Mobility, NMR LipoProfile®, or the Vertical Auto Profile (VAP®) cholesterol tests. In the case that measurements from an imaging test are used, the cIMT measure may be used, and preferably the average cIMT measurement. The virtual population was prevalence-weighted in accordance with the teachings of U.S. Patent Publication No. 2007-0026365, dated 1 Feb. 2007. The ARIC study includes clinical data from 15,792 patients in a population of 45-64 year old members from four U.S. communities: Forsyth County, N.C.; selected suburbs of Minneapolis, Minn.; Washington County, Md. and Jackson, Miss. Table 1 is limited to the data from ˜5000 white males, as Subject A is a white male.

Table I also illustrates that the prevalence-weighted virtual population was consistent with the population statistics associated with rs10757278.

TABLE I

| | | | | | | | | Virtual | |
|---|---|---|---|---|---|---|---|---|---|
| | | Subject “A” | | “A” relative to ARIC | | ARIC | | Population | |
| | | low | high | range | closer bound | mean | SD | mean | SD |
| TC | mg/dl | 209 | 231 | 50-90th | 50th | 207 | 39.5 | 210.65 | 41.02 |
| TG | mg/dl | 98.8 | 109.2 | 10-50th | 50th | 144.8 | 94.6 | 153.08 | 89.32 |
| LDL-C | mg/dl | 127.3 | 140.7 | 10-50th | 50th | 136 | 36.4 | 133.64 | 34.92 |
| HDL-C | mg/dl | 61.75 | 68.25 | 95-100th | 95th | 43.1 | 12.4 | 42.07 | 11.9 |
| IMT | microns | 590 | 650 | 50th | 75th* | 465 | 110 | 493.21 | 117.18 |

| | | Virtual |
|---|---|---|
| | ARIC | Population |
| rs10757278 | fraction | fraction |
| homo LR | 0.25 | 0.25 |
| hetero | 0.5 | 0.5 |
| homo HR | 0.25 | 0.25 |
| homo LR w/ events | 0.20 | 0.2 |
| hetero w/ events | 0.252 | 0.252 |
| homo HR w/ events | 0.328 | 0.328 |

*Howard, Stroke 1993

The entire virtual population described in Table 1 was filtered based on the actual data for Subject A. From the entire population of over 18,000 members, 421 virtual patients were selected as most similar to Subject A. Preferably a larger virtual population would be created, incorporating a broader range of virtual patient possibilities already calculated and validated. Each of these virtual patients also has an associated prevalence. FIG. 2 provides the cumulative incidence of myocardial infarction in these 421 identified virtual patients, as a function of time. The cumulative risk in FIG. 2 is illustrated by ranking the virtual patients by time of myocardial infraction (from zero to twenty years, with twenty years reflected on the graph in the case of no myocardial infarction). Then the y-axis of FIG. 2 provides the weighted prevalence of each virtual patient in the 421-patient virtual population representing Subject A. In chronological order, each myocardial infarction is indicated on the graph and the position on the y-axis indicates the total (additive) prevalence of all virtual patients that have, or previously had, a myocardial infarction at that time point.

FIG. 2 provides the cumulative risk of myocardial infarction for subject A as represented by his associated virtual population assuming average weight gain (1 lb/yr, solid circles), and stable weight. The computer model was also executed with weight gain, time and statin therapy as the virtual protocol. The addition of statin therapy noticeably decreases the cumulative risk of MI (see closed triangles and dotted line in FIG. 2).

Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method for predicting cardiovascular risk based a genetic marker status, the method comprising:
(a) providing a genetic marker status of a subject;
(b) providing a computer model of cardiovascular risk configured to account for the genetic marker, wherein the computer model comprises:
(i) a representation of cholesterol metabolism,
(ii) a representation of atherogenesis, and
(iii) a representation of plaque stability,
wherein a positive genetic marker status is indicated by an alteration in at least one of cholesterol metabolism, atherogenesis and plaque stability; and
(c) simulating and reporting an outcome for the subject.

2. The method of claim 1, wherein the representation of plaque stability accounts for smooth muscle dynamics and a positive genetic marker status is indicated by an alteration in smooth muscle cell dynamics.

3. The method of claim 1, wherein the genetic marker is a single nucleotide polymorphism (SNP).

4. The method of claim 3, wherein the SNP is located at chromosomal locus 9p21.

5. The method of claim 4, wherein the SNP is rs10757278(G) and the genetic marker status is positive.

6. The method of claim 5, wherein the positive genetic marker status is indicated by increased smooth muscle cell apoptosis and decreased smooth muscle cell proliferation in a plaque.

7. The method of claim 1, wherein the computer model of cardiovascular risk further is configured to account for imaging data about a subject and wherein the imaging data is indicated in the model by an alteration of at least one of cholesterol metabolism, atherogenesis and plaque stability.

8. The method of claim 1, wherein the computer model of cardiovascular risk further is configured to account for a blood measurement about a subject and wherein the blood measurement is indicated in the model by an alteration of at least one of cholesterol metabolism, atherogenesis and plaque stability.

9. A computer-implemented method of predicting a clinical outcome for a subject comprising:
(a) providing a virtual population comprising a plurality of virtual patients;
(b) receiving input data about a subject;
(c) selecting one or more virtual patients from the virtual population based on a similarity between each of the selected virtual patients and the input data;
(d) applying one or more virtual protocols to the one or more selected virtual patients to generate a set of outputs projecting a clinical outcome for the subject, wherein a set of outputs is generated for each selected virtual patient; and
(e) reporting the set of outputs to a user.

10. The method of claim 9, wherein each virtual patient of the virtual population has an associated prevalence.

11. The method of claim 10, wherein applying one or more virtual protocols to the one or more selected virtual patients comprises calculating a likelihood of each clinical outcome based upon the prevalence of the one or more virtual patients.

12. The method of claim 11, wherein the set of outputs comprises the likelihood of each clinical outcome.

13. The method of claim 9, wherein the virtual population is a prevalence-weighted virtual population, wherein each virtual patient of the virtual population has an associated prevalence weight.

14. The method of claim 9, wherein the virtual protocol is selected from the group consisting of a therapeutic regimen, passage of time, exercise, weight gain, diet, a lifestyle choice and a combination of two or more of the same.

15. The method of claim 9, wherein the virtual population accounts for a genetic marker.

16. The method of claim 10, wherein an effect of the genetic marker is represented as one or more axes of variation within the virtual population, wherein each virtual patient of the virtual patient population has an associated prevalence.

17. A method for modifying a computer model of a biological system to reflect genomic information, the method comprising:
(a) providing a computer model of a biological system in a computer-readable storage medium;
(b) providing a genetic marker having a known association with a clinical phenotype, wherein the genetic marker has a known locus on a chromosome;
(c) identifying one or more genes of known biological function that have linkage disequilibrium with the locus of the genetic marker;
(d) modifying the computer model to reflect the function of the one or more identified genes; and
(e) storing the modified computer model in a computer-readable storage medium.

18. The method of claim 17, wherein the computer model is modified to reflect the function of the one or more identified genes.

19. The method of claim 17, wherein the computer model is modified to reflect absence of the function of the one or more identified genes.

20. The method of claim 17, further comprising the step of
(f) executing the modified computer model to generate a simulated outcome; and
(g) comparing the simulated outcome with the known association between the genetic marker and clinical phenotype to confirm the validity of the modified computer model.

21. The method of claim 20, wherein comparing the simulated outcome with the known associate between the genetic marker and clinical phenotype comprises comparing a virtual population with a clinical population.

22. A computer model prepared in accordance with the method of claim 17.

23. A method of incorporating a genetic marker into a virtual population, said method comprising:
(a) providing an original virtual population having a set of population constraints;
(b) defining the effect of the genetic marker as one or more new axes of variation to be included in generating a new virtual population;
(c) generating virtual patients based on (i) the population constraints of the original virtual population and (ii) the one or more new axes of variation;
(d) assigning prevalence weights to the virtual population, incorporating population statistics for the genetic marker as a constraint in the prevalence weighting process; and
(e) generating an output comprising the virtual population and associated prevalence weights.

24. The method of claim 23, wherein the virtual population is provided as data stored on a computer readable medium.

25. The method of claim 23, wherein each allele for the genetic marker corresponds to a different quantitative position on the new axis of variation.

26. The method of claim 23, wherein the effect of the genetic marker is defined as a single new axis of variation.

27. The method of claim 23, wherein the effect of the genetic marker is defined as more than one new axis of variation.

28. The method of claim 23, wherein defining the effect of the genetic marker as one or more new axes of variation comprises:
(i) identifying the locus of the genetic marker on a chromosome;
(ii) identifying one or more genes of known biological function that have linkage disequilibrium with the locus of the genetic marker; and
(iii) defining the one or more new axes of variation based upon the known biological function of the one or more genes.

29. The method of claim 28, wherein the one or more new axes of variation reflect the function of the one or more identified genes.

30. The method of claim 28, wherein the one or more new axes of variation reflect absence of the function of the one or more identified genes.

31. The method of claim 28, wherein the one or more new axes of variation reflect a downstream effect of the function of the one or more identified genes.

32. A virtual population prepared in accordance with the method of claim 23.
